(19) United States
(12) Patent Application Publication
(10) Pub. No.: US 2025/0170855 A1
(43) Pub. Date: May 29, 2025

(54) TIRE

(71) Applicant: SUMITOMO RUBBER INDUSTRIES, LTD., Kobe-shi, Hyogo (JP)

(72) Inventor: Saki MUTO, Kobe-shi (JP)

(73) Assignee: SUMITOMO RUBBER INDUSTRIES, LTD., Kobe-shi, Hyogo (JP)

(21) Appl. No.: 18/843,532

(22) PCT Filed: Feb. 17, 2023
(86) PCT No.: PCT/JP2023/005636

§ 371 Date: Sep. 3, 2024

(30) Foreign Application Priority Data
Mar. 7, 2022 (JP) 2022-034505

(51) Int. Cl. B60C 1/00; C08K 3/04; C08K 3/22; C08K 3/36; C08L 9/06

(52) U.S. Cl. CPC B60C 1/0016; B60C 1/0025; C08K 3/04; C08K 3/22; C08K 3/36; C08L 9/06; C08K 2003/2296; C08L 2205/025; C08L 2205/035; C08L 2207/322

(57) ABSTRACT

Provided is a tire with increased crack growth resistance. The present disclosure relates to a tire, including a tire external layer component including a rubber composition that contains a rubber component, an acid-modified liquid polymer, and a metal filler, the tire satisfying the following formula (1):

$$0.4 \leq F / T \leq 10.0 \qquad ( 1 )$$

where F denotes an amount (parts by mass) of the metal filler per 100 parts by mass of the rubber component, and T denotes a largest thickness (mm) of the tire external layer component.

### TECHNICAL FIELD

The present disclosure relates to a tire.

### BACKGROUND ART

Tire external layer components such as treads and sidewalls are requested to exhibit increased crack growth resistance by suppressing cracks and the like on their surfaces, etc. Further improvement is desired.

### SUMMARY OF DISCLOSURE

### Technical Problem

The present disclosure aims to solve the above problem and provide a tire with increased crack growth resistance.

### Solution to Problem

The present disclosure relates to a tire, including a tire external layer component including a rubber composition that contains a rubber component, an acid-modified liquid polymer, and a metal filler,
the tire satisfying the following formula (1):

$$0.4 \leq F / T \leq 10.0 \qquad ( 1 )$$

where F denotes an amount (parts by mass) of the metal filler per 100 parts by mass of the rubber component, and T denotes a largest thickness (mm) of the tire external layer component.

### Advantageous Effects of Disclosure

The tire of the present disclosure includes a tire external layer component including a rubber composition that contains a rubber component, an acid-modified liquid polymer, and a metal filler, and satisfies the formula (1). The tire obtains increased crack growth resistance.

### BRIEF DESCRIPTION OF DRAWINGS

FIG. 1 shows a cross-sectional view of a part of a pneumatic tire 2.

FIG. 2 shows an enlarged cross-sectional view of a tread portion 4 and its vicinity of the tire 2 in FIG. 1.

### DESCRIPTION OF EMBODIMENTS

The tire of the present disclosure includes a tire external layer component including a rubber composition that contains a rubber component, an acid-modified liquid polymer, and a metal filler, and satisfies the formula (1).

The tire can exhibit the above-described advantageous effect probably for the following reason.

When an acid-modified liquid polymer and a metal filler are used, the metal filler is attracted (by ionic bonds) to the acid portion of the acid-modified liquid polymer, so that the metal filler is unevenly distributed in the island phases. Further, sulfur is attracted to the metal filler, so that the sulfur is unevenly distributed in the island phases. This causes a difference in cross-linking density between the sea phase (low cross-linking density) and the island phases (high cross-linking density). Due to the low cross-linking density of the sea phase, the force on the sea phase is dispersed, thereby reducing crack growth. Moreover, due to the hard island phases, cracks grow while avoiding the island phases. Presumably, the crack growth resistance is thus increased.

Further, the metal filler portions form island phase-like portions. When the tire external layer component has a large thickness, the surface distortion increases. Therefore, the formula (1): 0.4≤F/T≤10.0 is satisfied to increase the amount of the metal filler as the thickness increases, thereby increasing the island phases. Thus, even under high distortion, cracks tend to grow while avoiding the island phases. Consequently, crack growth resistance is increased.

Presumably, based on the above-described mechanism, tires that contain an acid-modified liquid polymer and a metal filler and also satisfy the formula (1) obtain excellent crack growth resistance.

As described above, the present disclosure solves the problem (aim) in increasing crack growth resistance by developing a tire that includes a tire external layer component including a rubber composition containing a rubber component, an acid-modified liquid polymer, and a metal filler and also satisfies the formula (1): 0.4≤F/T≤10.0. In other words, the parameters of the formula (1): 0.4≤F/T≤10.0 do not define the problem (aim). The problem herein is to increase crack growth resistance. In order to solve the problem, the tire has been formulated to satisfy the parameters.

The tire of the present disclosure is described below. First, a rubber composition for a tire external layer component included in the tire external layer component is described.

### (Rubber Composition for a Tire External Layer Component)

The external layer component including the rubber composition for a tire external layer component may be any component whose surface is at least partly exposed. Examples include treads, sidewalls, clinches, and innerliners. In order to better achieve the advantageous effect, it is suitably a tread or a sidewall.

The rubber composition for a tire external layer component contains a rubber component.

The rubber component in the rubber composition for a tire external layer component contributes to cross-linking and is usually a polymer having a weight average molecular weight (Mw) of 10000 or more. The polymer is solid at room temperature (25° C.).

The weight average molecular weight of the rubber component is preferably 50000 or more, more preferably 150000 or more, still more preferably 200000 or more, while it is preferably 2000000 or less, more preferably 1500000 or less, still more preferably 1000000 or less. When the weight average molecular weight is within the range indicated above, the advantageous effect tends to be better achieved.

Herein, the weight average molecular weight (Mw) can be measured by gel permeation chromatography (GPC) (GPC-8000 series available from Tosoh Corporation, detector: differential refractometer, column: TSKgel SuperMultipore HZ-M available from Tosoh Corporation) and calibrated with polystyrene standards.

The rubber component is not limited. Rubber components known in the tire field may be used. Examples include diene-based rubbers such as isoprene-based rubbers, polybutadiene rubber (BR), styrene-butadiene rubber (SBR), acrylonitrile-butadiene rubber (NBR), chloroprene rubber (CR), butyl rubber (IIR), and styrene-isoprene-butadiene copolymer rubber (SIBR). These may be used alone or in combinations of two or more. To better achieve the advantageous effect, isoprene-based rubbers, BR, and SBR are preferred. In particular, SBR and BR are desirable for treads, while isoprene-based rubbers and BR are desirable for sidewalls.

Examples of isoprene-based rubbers include natural rubbers (NR), polyisoprene rubber (IR), refined NR, modified NR, and modified IR. Examples of NR include those commonly used in the tire industry such as SIR20, RSS #3, and TSR20. Any IR may be used, including for example those commonly used in the tire industry such as IR2200. Examples of refined NR include deproteinized natural rubbers (DPNR) and highly purified natural rubbers (UPNR). Examples of modified NR include epoxidized natural rubbers (ENR), hydrogenated natural rubbers (HNR), and grafted natural rubbers. Examples of modified IR include epoxidized polyisoprene rubbers, hydrogenated polyisoprene rubbers, and grafted polyisoprene rubbers. These may be used alone or in combinations of two or more. NR is preferred among these.

The amount of isoprene-based rubbers, if present, in the rubber composition for a tire external layer component based on 100% by mass of the rubber component is preferably 5% by mass or more, more preferably 10% by mass or more, while it is preferably 80% by mass or less, more preferably 70% by mass or less, still more preferably 60% by mass or less. When the amount is within the range indicated above, the advantageous effect tends to be better achieved.

The amount of isoprene-based rubbers based on 100% by mass of the rubber component in the rubber composition for sidewalls is preferably 5% by mass or more, more preferably 20% by mass or more, still more preferably 30% by mass or more, particularly preferably 40% by mass or more, most preferably 41% by mass or more, while it is preferably 80% by mass or less, more preferably 70% by mass or less, still more preferably 60% by mass or less. When the amount is within the range indicated above, the advantageous effect tends to be better achieved.

Any BR may be used, and examples include those commonly used in the tire industry, including: high-cis BR such as BR1220 available from Zeon Corporation, BR150B available from Ube Industries, Ltd., and BR1280 available from LG Chem; BR containing 1,2-syndiotactic polybutadiene crystals (SPB) such as VCR412 and VCR617 both available from Ube Industries, Ltd.; and polybutadiene rubber synthesized using rare earth catalysts (rare earth-catalyzed BR). These may be used alone or in combinations of two or more.

The cis content of the BR is preferably 80% by mass or higher, more preferably 85% by mass or higher, still more preferably 90% by mass or higher, while it is preferably 99% by mass or lower, more preferably 98% by mass or lower, still more preferably 97% by mass or lower. When the cis content is within the range indicated above, the advantageous effect tends to be better achieved.

Here, the cis content of the BR can be measured by infrared absorption spectrometry.

When one type of BR is used, the cis content of the BR refers to the cis content of the one BR. When multiple types of BR are used, it refers to the average cis content.

The average cis content of the BR can be calculated using the equation: {Σ(amount of each BR×cis content of the each BR)}/amount of total BR. For example, when 100% by mass of the rubber component includes 20% by mass of a BR having a cis content of 90% by mass and 10% by mass of a BR having a cis content of 40% by mass, the average cis content of the BR is 73.3% by mass (=(20×90+10×40)/(20+10)).

The amount of BR, if present, in the rubber composition for a tire external layer component based on 100% by mass of the rubber component is preferably 5% by mass or more, more preferably 10% by mass or more, still more preferably 15% by mass or more, while it is preferably 80% by mass or less, more preferably 70% by mass or less, still more preferably 60% by mass or less. When the amount is within the range indicated above, the advantageous effect tends to be better achieved.

The amount of BR based on 100% by mass of the rubber component in the rubber composition for treads is preferably 5% by mass or more, more preferably 10% by mass or more, still more preferably 15% by mass or more, particularly preferably 18% by mass or more, while it is preferably 80% by mass or less, more preferably 70% by mass or less, still more preferably 60% by mass or less. When the amount is within the range indicated above, the advantageous effect tends to be better achieved.

The amount of BR based on 100% by mass of the rubber component in the rubber composition for sidewalls is preferably 5% by mass or more, more preferably 20% by mass or more, still more preferably 30% by mass or more, particularly preferably 50% by mass or more, while it is preferably 80% by mass or less, more preferably 70% by mass or less, still more preferably 60% by mass or less, particularly preferably 59% by mass or less. When the amount is within the range indicated above, the advantageous effect tends to be better achieved.

Any SBR may be used, and examples include emulsion-polymerized styrene-butadiene rubbers (E-SBR) and solution-polymerized styrene-butadiene rubbers (S-SBR). Examples of commercial products include those available from Sumitomo Chemical Co., Ltd., JSR Corporation, Asahi Kasei Corporation, Zeon Corporation, etc.

The styrene content of the SBR is preferably 5% by mass or higher, more preferably 10% by mass or higher, still more preferably 15% by mass or higher, particularly preferably 20% by mass or higher, most preferably 27% by mass or higher. The styrene content is preferably 50% by mass or lower, more preferably 45% by mass or lower, still more preferably 40% by mass or lower. When the styrene content is within the range indicated above, the advantageous effect tends to be better achieved.

Herein, the styrene content of the SBR can be determined by 1H-NMR analysis.

When one type of SBR is used, the styrene content of the SBR refers to the styrene content of the one SBR. When multiple types of SBR are used, it refers to the average styrene content.

The average styrene content of the SBR can be calculated using the equation: {Σ(amount of each SBR×styrene content of the each SBR)}/amount of total SBR. For example, when 100% by mass of the rubber component includes 85% by mass of a SBR having a styrene content of 40% by mass and 5% by mass of a SBR having a styrene content of 25% by mass, the average styrene content of the SBR is 39.2% by mass (=(85×40+5×25)/(85+5)).

The vinyl content of the SBR is preferably 10% by mass or higher, more preferably 20% by mass or higher, still more preferably 30% by mass or higher. The vinyl content is preferably 90% by mass or lower, more preferably 80% by mass or lower, still more preferably 70% by mass or lower. When the vinyl content is within the range indicated above, the advantageous effect tends to be better achieved.

Herein, the vinyl content (1,2-bonded butadiene unit content) of the SBR can be measured by infrared absorption spectrometry.

The vinyl content (1,2-bonded butadiene unit content) of the SBR refers to the ratio of vinyl bonds (unit: % by mass) based on the total mass of the butadiene moieties in the SBR taken as 100. The sum of the vinyl content (% by mass), the cis content (% by mass), and the trans content (% by mass) equals 100 (% by mass). When one type of SBR is used, the vinyl content of the SBR refers to the vinyl content of the one SBR. When multiple types of SBR are used, it refers to the average vinyl content.

The average vinyl content of the SBR can be calculated using the equation: Σ{amount of each SBR×(100 (% by mass)−styrene content (% by mass) of the each SBR)×vinyl content (% by mass) of the each SBR}/Σ{amount of each SBR×(100 (% by mass)−styrene content (% by mass) of the each SBR)}. For example, when 100 parts by mass of the rubber component includes 75 parts by mass of a SBR having a styrene content of 40% by mass and a vinyl content of 30% by mass, 15 parts by mass of a SBR having a styrene content of 25% by mass and a vinyl content of 20% by mass, and the remaining 10 parts by mass of a rubber component other than SBR, the average vinyl content of the SBR is 28% by mass (={75×(100 (% by mass)−40 (% by mass))×30 (% by mass)+15×(100 (% by mass)−25 (% by mass))×20 (% by mass)}/{75×(100 (% by mass)−40 (% by mass))+15×(100 (% by mass)−25 (% by mass))}.

The amount of SBR, if present, in the rubber composition for a tire external layer component based on 100% by mass of the rubber component is preferably 5% by mass or more, more preferably 10% by mass or more, still more preferably 20% by mass or more, particularly preferably 30% by mass or more, while it is preferably 95% by mass or less, more preferably 90% by mass or less. When the amount is within the range indicated above, the advantageous effect tends to be better achieved.

The amount of SBR based on 100% by mass of the rubber component in the rubber composition for treads is preferably 5% by mass or more, more preferably 10% by mass or more, still more preferably 20% by mass or more, particularly preferably 30% by mass or more, while it is preferably 95% by mass or less, more preferably 90% by mass or less, still more preferably 82% by mass or less. When the amount is within the range indicated above, the advantageous effect tends to be better achieved.

The rubber component may include oil-extended rubbers which have been extended with an oil. These may be used alone or in combinations of two or more. Examples of the oil used in oil-extended rubbers include those described below. The amount of the oil in the oil-extended rubbers is not limited, and it is usually about 10 to 50 parts by mass per 100 parts by mass of the rubber solids content.

The rubber component may be modified to introduce therein a functional group interactive with filler such as silica.

Examples of the functional group include a silicon-containing group (—SiR₃ where each R is the same or different and represents a hydrogen atom, a hydroxyl group, a hydrocarbon group, an alkoxy group, or the like), an amino group, an amide group, an isocyanate group, an imino group, an imidazole group, a urea group, an ether group, a carbonyl group, an oxycarbonyl group, a mercapto group, a sulfide group, a disulfide group, a sulfonyl group, a sulfinyl group, a thiocarbonyl group, an ammonium group, an imide group, a hydrazo group, an azo group, a diazo group, a carboxy group, a nitrile group, a pyridyl group, an alkoxy group, a hydroxyl group, an oxy group, and an epoxy group, each of which may be substituted. Preferred among these is a silicon-containing group. More preferred is-SiR₃ where each R is the same or different and represents a hydrogen atom, a hydroxyl group, a hydrocarbon group (preferably a C₁-C₆ hydrocarbon group, more preferably a C₁-C₆ alkyl group), or an alkoxy group (preferably a C₁-C₆ alkoxy group).

Specific examples of the compound (modifier) used to introduce the functional group include 3-aminopropyltrimethoxisilane, 3-aminopropyltriethoxisilane, 3-aminopropyldimethylmethoxisilane, 3-aminopropylmethyldimethoxisilane, 2-dimethylaminoethyltrimethoxysilane, 3-dimethylaminopropyltrimethoxysilane, 2-dimethylaminoethyltriethoxysilane, 3-dimethylaminopropyltriethoxysilane, 2-diethylaminoethyltrimethoxysilane, 3-diethylaminopropyltrimethoxysilane, 2-diethylaminoethyltriethoxysilane, and 3-diethylaminopropyltriethoxysilane.

The total amount of SBR and BR based on 100% by mass of the rubber component in the rubber composition for treads is preferably 50% by mass or more, more preferably 60% by mass or more, and may be 100% by mass. When the total amount is within the range indicated above, the advantageous effect tends to be better achieved.

The total amount of isoprene-based rubbers and BR based on 100% by mass of the rubber component in the rubber composition for sidewalls is preferably 50% by mass or more, more preferably 70% by mass or more, still more preferably 80% by mass or more, particularly preferably 90% by mass or more, and may be 100% by mass. When the total amount is within the range indicated above, the advantageous effect tends to be better achieved.

The rubber composition for a tire external layer component contains an acid-modified liquid polymer.

The acid-modified liquid polymer is liquid at room temperature (25° C.). The acid-modified liquid polymer may be used alone or in combinations of two or more.

Examples of the acid-modified liquid polymer include polymers which have been modified with acid compounds or derivatives thereof and which are liquid at room temperature (25° C.).

Specific examples of suitably usable acid-modified liquid polymers include acid-modified liquid polymers obtained by modifying unmodified liquid polymers with unsaturated carboxylic acids and/or derivatives thereof and acid-modified liquid polymers obtained by modifying modified liquid polymers with unsaturated carboxylic acids and/or derivatives thereof. In particular, acid-modified liquid polymers obtained by modifying unmodified liquid polymers with unsaturated carboxylic acids and/or derivatives thereof are desirably used.

The unmodified liquid polymers are unmodified liquid polymers (liquid diene-based polymers) obtained by polymerizing a conjugated diene-containing monomer, such as 1,3-butadiene, isoprene, 1,3-pentadiene, 2,3-dimethyl-1,3-butadiene, 2-methyl-1,3-pentadiene, 1,3-hexadiene, 2-methyl-1,3-pentadiene, 4,5-diethyl-1,3-octadiene, or 3-butyl-1,3-octadiene. Examples of the unmodified liquid polymers include liquid diene-based polymers, such as liquid polybutadiene, liquid polyisoprene, liquid styrene-butadiene random copolymers, liquid styrene-butadiene block copolymers, liquid butadiene-isoprene random copolymers, liquid butadiene-isoprene block copolymers, liquid styrene-butadiene-isoprene random copolymers, and liquid styrene-butadiene-isoprene block copolymers. In order to better achieve the advantageous effect, liquid polybutadiene, liquid polyisoprene, liquid styrene-butadiene random copolymers, and liquid styrene-butadiene block copolymers are preferred among these, with liquid polybutadiene and liquid polyisoprene being more preferred. These may be used alone or in admixtures of two or more.

Examples of the unsaturated carboxylic acids include maleic acid, fumaric acid, itaconic acid, and (meth)acrylic acid. Examples of derivatives of the unsaturated carboxylic acids include unsaturated carboxylic anhydrides such as maleic anhydride and itaconic anhydride; unsaturated carboxylic acid esters such as maleate, fumarate, itaconate, glycidyl (meth)acrylate, and hydroxyethyl (meth)acrylate; unsaturated carboxylic acid amides such as maleic acid amide, fumaric acid amide, and itaconic acid amide; unsaturated carboxylic acid imides such as maleic acid imide and itaconic acid imide. The unmodified liquid polymers and the modified liquid polymers may each be modified with one or two or more unsaturated carboxylic acids or one or two or more unsaturated carboxylic acid derivatives.

The acid-modified liquid polymer may be produced by modifying an unmodified liquid polymer as a raw material with an acid compound such as an unsaturated carboxylic acid and/or a derivative thereof. Non-limiting examples of the modification method include known methods, including a method of adding an acid compound such as an unsaturated carboxylic acid and/or a derivative thereof to an unmodified liquid polymer as a raw material. The acid-modified liquid polymer may be used alone or in combinations of two or more.

In order to better achieve the advantageous effect, maleic acid-modified liquid polymers and maleic anhydride-modified liquid polymers are preferred, maleic acid-modified liquid diene-based polymers and maleic anhydride-modified liquid diene-based polymers are more preferred, maleic acid-modified liquid polybutadiene, maleic anhydride-modified liquid polybutadiene, maleic acid-modified liquid polyisoprene, and maleic anhydride-modified liquid polyisoprene are still more preferred among the acid-modified liquid polymers.

The number average molecular weight (Mn) of the acid-modified liquid polymer is preferably 2000 or more, more preferably 2700 or more, still more preferably 25000 or more, particularly preferably 30000 or more. The Mn is preferably 100000 or less, more preferably 80000 or less, still more preferably 60000 or less, particularly preferably 34000 or less. The weight average molecular weight (Mw) of the acid-modified liquid polymer is desirably within the range indicated above. When the Mn and Mw are within the range indicated above, the advantageous effect tends to be better achieved.

The acid-modified liquid polymer may be a product of, for example, Kuraray, Clay Valley, etc.

The amount of the acid-modified liquid polymer per 100 parts by mass of the rubber component in the rubber composition for a tire external layer component is preferably 5 parts by mass or more, more preferably 10 parts by mass or more, still more preferably 13 parts by mass or more, further preferably 15 parts by mass or more, particularly preferably 18 parts by mass or more. The amount is preferably 35 parts by mass or less, more preferably 30 parts by mass or less, still more preferably 25 parts by mass or less, particularly preferably 23 parts by mass or less. When the amount is within the range indicated above, the advantageous effect tends to be better achieved.

The amount of the acid-modified liquid polymer per 100 parts by mass of the rubber component in the rubber composition for treads is preferably 5 parts by mass or more, more preferably 10 parts by mass or more, still more preferably 13 parts by mass or more, further preferably 15 parts by mass or more, particularly preferably 18 parts by mass or more. The amount is preferably 35 parts by mass or less, more preferably 30 parts by mass or less, still more preferably 25 parts by mass or less, particularly preferably 23 parts by mass or less. When the amount is within the range indicated above, the advantageous effect tends to be better achieved.

The amount of the acid-modified liquid polymer per 100 parts by mass of the rubber component in the rubber composition for sidewalls is preferably 5 parts by mass or more, more preferably 10 parts by mass or more, still more preferably 13 parts by mass or more, further preferably 15 parts by mass or more, particularly preferably 18 parts by mass or more. The amount is preferably 35 parts by mass or less, more preferably 30 parts by mass or less, still more preferably 25 parts by mass or less, particularly preferably 23 parts by mass or less. When the amount is within the range indicated above, the advantageous effect tends to be better achieved.

The rubber composition for a tire external layer component contains a metal filler.

The metal filler in the present disclosure is at least one selected from the group consisting of metal oxides, metal hydroxides, metal chlorides, metal carbonates, metal acetates, and metal phosphates. The metal is at least one metal selected from the group consisting of sodium (Na), potassium (K), beryllium (Be), magnesium (Mg), calcium (Ca), zinc (Zn), aluminum (Al), iron (Fe), and titanium (Ti). Zinc oxide is preferred among these.

The zinc oxide is not limited, and those generally used in the rubber field such as tires are usable. In addition to usual zinc oxide, zinc oxide fine particles are also suitably usable. Examples of zinc oxide fine particles include zinc oxide having an average primary particle size of 200 nm or less. The average primary particle size is preferably 100 nm or less. The lower limit is not limited and it is preferably 20 nm or more, more preferably 30 nm or more. Herein, the average primary particle size of zinc oxide refers to an average particle size (average primary particle size) calculated from a specific surface area determined on the basis of nitrogen adsorption by the BET method.

The metal filler such as zinc oxide may be a conventionally known one. Usable zinc oxide may be commercially available from Mitsui Mining & Smelting Co., Ltd., Toho Zinc Co., Ltd., Hakusui Tech Co., Ltd., Seido Chemical Industry Co., Ltd., Sakai Chemical Industry Co., Ltd., etc.

The amount of the metal filler (preferably, the amount of zinc oxide) per 100 parts by mass of the rubber component in the rubber composition for a tire external layer component is preferably 0.5 parts by mass or more, more preferably 0.9 parts by mass or more, still more preferably 1.5 parts by mass or more, further preferably 2.0 parts by mass or more, further preferably 4.0 parts by mass or more, further preferably 4.2 parts by mass or more, further preferably 4.4 parts by mass or more, further preferably 4.7 parts by mass or more, further preferably 4.9 parts by mass or more, further preferably 5.2 parts by mass or more, further preferably 5.4 parts by mass or more. The amount is preferably 50.0 parts by mass or less, more preferably 30.0 parts by mass or less, still more preferably 20.0 parts by mass or less, further preferably 10.0 parts by mass or less. When the amount is within the range indicated above, the advantageous effect tends to be better achieved.

The amount of the metal filler (preferably, the amount of zinc oxide) per 100 parts by mass of the rubber component in the rubber composition for treads is preferably 1.0 parts by mass or more, more preferably 2.0 parts by mass or more, still more preferably 3.0 parts by mass or more, further preferably 3.5 parts by mass or more, further preferably 4.0 parts by mass or more, further preferably 4.2 parts by mass or more, further preferably 4.7 parts by mass or more, further preferably 5.2 parts by mass or more. The amount is preferably 50.0 parts by mass or less, more preferably 20.0 parts by mass or less, further preferably 10.0 parts by mass or less. When the amount is within the range indicated above, the advantageous effect tends to be better achieved.

The amount of the metal filler (preferably, the amount of zinc oxide) per 100 parts by mass of the rubber component in the rubber composition for sidewalls is preferably 0.5 parts by mass or more, more preferably 0.9 parts by mass or more, still more preferably 1.2 parts by mass or more, further preferably 1.5 parts by mass or more, further preferably 4.0 parts by mass or more, further preferably 4.4 parts by mass or more, further preferably 4.9 parts by mass or more, further preferably 5.4 parts by mass or more. The amount is preferably 30.0 parts by mass or less, more preferably 20.0 parts by mass or less, further preferably 10.0 parts by mass or less. When the amount is within the range indicated above, the advantageous effect tends to be better achieved.

The rubber composition for a tire external layer component desirably contains a different filler other than the metal filler.

The amount of the different filler (total amount of different fillers such as carbon black and silica) per 100 parts by mass of the rubber component in the rubber composition for a tire external layer component is preferably 30 parts by mass or more, more preferably 40 parts by mass or more, still more preferably 47 parts by mass or more. The upper limit of the amount is preferably 150 parts by mass or less, more preferably 100 parts by mass or less, still more preferably 100 parts by mass or less, further preferably 80 parts by mass or less, further preferably 77 parts by mass or less. When the amount is within the range indicated above, the advantageous effect tends to be better achieved.

Different fillers are not limited, and materials known in the rubber field are usable. Examples include inorganic fillers such as silica, carbon black, calcium carbonate, talc, alumina, clay, aluminum hydroxide, aluminum oxide, and mica. To better achieve the advantageous effect, carbon black and silica are preferred.

Any carbon black may be used in the rubber composition for a tire external layer component, and examples include N134, N110, N220, N234, N219, N339, N330, N326, N351, N550, and N762. Usable commercial products are available from Asahi Carbon Co., Ltd., Cabot Japan K.K., Tokai Carbon Co., Ltd., Mitsubishi Chemical Corporation, Lion Corporation, NSCC Carbon Co., Ltd., Columbia Carbon, etc. These may be used alone or in combinations of two or more.

The nitrogen adsorption specific surface area (N₂SA) of the carbon black in the rubber composition for a tire external layer component is preferably 30 m²/g or more, more preferably 35 m²/g or more, still more preferably 40 m²/g or more. The N₂SA is preferably 200 m²/g or less, more preferably 150 m²/g or less, still more preferably 130 m²/g or less, further preferably 120 m²/g or less. When the N₂SA is within the range indicated above, the advantageous effect tends to be better achieved.

Here, the N₂SA of the carbon black can be determined in accordance with JIS K 6217-2:2001.

The nitrogen adsorption specific surface area (N₂SA) of the carbon black in the rubber composition for treads is preferably 80 m²/g or more, more preferably 100 m²/g or more, still more preferably 110 m²/g or more. The N₂SA is preferably 200 m²/g or less, more preferably 150 m²/g or less, still more preferably 130 m²/g or less. When the N₂SA is within the range indicated above, the advantageous effect tends to be better achieved.

The nitrogen adsorption specific surface area (N₂SA) of the carbon black in the rubber composition for sidewalls is preferably 30 m²/g or more, more preferably 35 m²/g or more, still more preferably 40 m²/g or more, further preferably 42 m²/g or more. The N₂SA is preferably 100 m²/g or less, more preferably 80 m²/g or less, still more preferably 60 m²/g or less, further preferably 50 m²/g or less. When the N₂SA is within the range indicated above, the advantageous effect tends to be better achieved.

The amount of carbon black, if present, in the rubber composition for a tire external layer component per 100 parts by mass of the rubber component is preferably 1 part by mass or more, more preferably 3 parts by mass or more, still more preferably 5 parts by mass or more, further preferably 6 parts by mass or more. The upper limit of the amount is preferably 60 parts by mass or less, more preferably 50 parts by mass or less, still more preferably 47 parts by mass or less, further preferably 40 parts by mass or less. When the amount is within the range indicated above, the advantageous effect tends to be better achieved.

The amount of carbon black per 100 parts by mass of the rubber component in the rubber composition for treads is preferably 1 part by mass or more, more preferably 3 parts by mass or more, still more preferably 5 parts by mass or more, further preferably 6 parts by mass or more. The upper limit of the amount is preferably 30 parts by mass or less, more preferably 20 parts by mass or less, still more preferably 10 parts by mass or less. When the amount is within the range indicated above, the advantageous effect tends to be better achieved.

The amount of carbon black per 100 parts by mass of the rubber component in the rubber composition for sidewalls is preferably 10 parts by mass or more, more preferably 20 parts by mass or more, still more preferably 30 parts by mass or more. The upper limit of the amount is preferably 70 parts by mass or less, more preferably 60 parts by mass or less, still more preferably 50 parts by mass or less, further preferably 47 parts by mass or less. When the amount is within the range indicated above, the advantageous effect tends to be better achieved.

Examples of usable silica include dry silica (anhydrous silica) and wet silica (hydrous silica). Wet silica is preferred among these because it contains a large number of silanol groups. Examples of usable commercial products include those available from Degussa, Rhodia, Tosoh Silica Corporation, Solvay Japan, Tokuyama Corporation, etc. These may be used alone or in combinations of two or more.

The nitrogen adsorption specific surface area (N₂SA) of the silica is preferably 50 m²/g or more, more preferably 100 m²/g or more, still more preferably 150 m²/g or more, further preferably 160 m²/g or more, particularly preferably 170 m²/g or more. The upper limit of the N₂SA of the silica is not limited, and it is preferably 350 m²/g or less, more preferably 300 m²/g or less, still more preferably 250 m²/g or less. When the N₂SA is within the range indicated above, the advantageous effect tends to be better achieved.

Here, the N₂SA of the silica is measured by a BET method in accordance with ASTM D3037-93.

The amount of silica, if present, in the rubber composition for a tire external layer component per 100 parts by mass of the rubber component is preferably 30 parts by mass or more, more preferably 40 parts by mass or more. The upper limit of the amount is preferably 150 parts by mass or less, more preferably 120 parts by mass or less, still more preferably 100 parts by mass or less, further preferably 80 parts by mass or less, further preferably 71 parts by mass or less. When the amount is within the range indicated above, the advantageous effect tends to be better achieved.

The amount of silica per 100 parts by mass of the rubber component in the rubber composition for treads is preferably 30 parts by mass or more, more preferably 40 parts by mass or more. The upper limit of the amount is preferably 150 parts by mass or less, more preferably 120 parts by mass or less, still more preferably 100 parts by mass or less, further preferably 80 parts by mass or less, further preferably 71 parts by mass or less. When the amount is within the range indicated above, the advantageous effect tends to be better achieved.

When the rubber composition for a tire external layer component contains silica, preferably, it further contains a silane coupling agent.

The silane coupling agent may be any silane coupling agent including those known in the rubber field. Examples include sulfide silane coupling agents such as bis(3-triethoxysilylpropyl) tetrasulfide, bis(2-triethoxysilylethyl)tetrasulfide, bis(4-triethoxysilylbutyl)tetrasulfide, bis(3-trimethoxysilylpropyl) tetrasulfide, bis(2-trimethoxysilylethyl)tetrasulfide, bis(2-triethoxysilylethyl)trisulfide, bis(4-trimethoxysilylbutyl)trisulfide, bis(3-triethoxysilylpropyl) disulfide, bis(2-triethoxysilylethyl)disulfide, bis(4-triethoxysilylbutyl)disulfide, bis(3-trimethoxysilylpropyl) disulfide, bis(2-trimethoxysilylethyl)disulfide, bis(4-trimethoxysilylbutyl)disulfide, 3-trimethoxysilylpropyl-N, N-dimethylthiocarbamoyltetrasulfide, 2-triethoxysilylethyl-N, N-dimethylthiocarbamoyltetrasulfide, and 3-triethoxysilylpropyl methacrylate monosulfide; mercapto silane coupling agents such as 3-mercaptopropyltrimethoxysilane, 2-mercaptoethyltriethoxysilane, and NXT and NXT-Z both available from Momentive; vinyl silane coupling agents such as vinyltriethoxysilane and vinyltrimethoxysilane; amino silane coupling agents such as 3-aminopropyltriethoxysilane and 3-aminopropyltrimethoxysilane; glycidoxy silane coupling agents such as γ-glycidoxypropyltriethoxysilane and γ-glycidoxypropyltrimethoxysilane; nitro silane coupling agents such as 3-nitropropyltrimethoxysilane and 3-nitropropyltriethoxysilane; and chloro silane coupling agents such as 3-chloropropyltrimethoxysilane and 3-chloropropyltriethoxysilane. Usable commercial products are available from Degussa, Momentive, Shin-Etsu Silicone, Tokyo Chemical Industry Co., Ltd., AZmax. Co., Dow Corning Toray Co., Ltd., etc. These may be used alone or in combinations of two or more.

The amount of silane coupling agents per 100 parts by mass of silica in the rubber composition for a tire external layer component is preferably 0.1 parts by mass or more, more preferably 3 parts by mass or more, still more preferably 5 parts by mass or more, particularly preferably 7 parts by mass or more. The upper limit of the amount is preferably 50 parts by mass, more preferably 20 parts by mass or less, still more preferably 15 parts by mass or less, particularly preferably 10 parts by mass or less. When the amount is within the range indicated above, the advantageous effect tends to be better achieved.

The rubber composition for a tire external layer component may contain a plasticizer that can impart plasticity to rubber components. Examples of the plasticizer include liquid plasticizers (plasticizers which are liquid (in a liquid state) at 25° C.) and solid plasticizers (plasticizers which are solid at 25° C.). The plasticizer may be used alone or in combinations of two or more.

Non-limiting examples of liquid plasticizers include the above-described acid-modified liquid polymer as well as oils and liquid resins and liquid diene-based polymers other than the acid-modified liquid polymer. In order to better achieve the advantageous effect, oils are preferred among these.

Non-limiting examples of the oils include known oils, including process oils, plant oils, and mixtures of these oils. Examples of process oils include paraffinic process oils (mineral oils), aromatic process oils, naphthenic process oils, and low polycyclic aromatic (PCA) process oils such as TDAE and MES. Examples of plant oils include castor oil, cottonseed oil, linseed oil, rapeseed oil (canola oil), soybean oil, palm oil, coconut oil, peanut oil, rosin, pine oil, pine tar, tall oil, corn oil, rice oil, safflower oil, sesame oil, olive oil, sunflower oil, palm kernel oil, camellia oil, macadamia nut oil, and tung oil. These may be use alone or in combinations of two or more.

The amount of liquid plasticizers (total amount of the acid-modified liquid polymer, oils, etc.), if present, in the rubber composition for a tire external layer component per 100 parts by mass of the rubber component is preferably 5 parts by mass or more, more preferably 7 parts by mass or more, still more preferably 10 parts by mass or more. The upper limit is preferably 50 parts by mass or less, more preferably 30 parts by mass or less, still more preferably 20 parts by mass or less. When the amount is within the range indicated above, the advantageous effect tends to be better achieved.

The amount of liquid plasticizers (total amount of the acid-modified liquid polymer, oils, etc.) per 100 parts by mass of the rubber component in the rubber composition for sidewalls is preferably 5 parts by mass or more, more preferably 7 parts by mass or more, still more preferably 10 parts by mass or more, further preferably 12 parts by mass or more. The upper limit is preferably 50 parts by mass or less, more preferably 30 parts by mass or less, still more preferably 20 parts by mass or less. When the amount is within the range indicated above, the advantageous effect tends to be better achieved. The amount of oils is also desirably within the range indicated above.

Examples of solid plasticizers include aromatic vinyl polymers, coumarone-indene resins, coumarone resins, indene resins, phenol resins, rosin resins, petroleum resins, terpene resins, and acrylic resins, all of which are solid at room temperature (25° C.). The resins may be hydrogenated. These may be used alone or in combinations of two or more.

The amount of solid plasticizers, if present, in the rubber composition for a tire external layer component per 100 parts by mass of the rubber component is preferably 5 parts by mass or more, more preferably 10 parts by mass or more, still more preferably 13 parts by mass or more, particularly preferably 15 parts by mass or more. The upper limit is preferably 50 parts by mass or less, more preferably 45 parts by mass or less, still more preferably 40 parts by mass or less.

The rubber composition for a tire external layer component may contain an antioxidant.

Examples of the antioxidant include naphthylamine antioxidants such as phenyl-α-naphthylamine; diphenylamine antioxidants such as octylated diphenylamine and 4,4′-bis(α,α′-dimethylbenzyl)diphenylamine; p-phenylenediamine antioxidants such as N-isopropyl-N′-phenyl-p-phenylenediamine, N-(1,3-dimethylbutyl)-N′-phenyl-p-phenylenediamine, and N,N′-di-2-naphthyl-p-phenylenediamine; quinoline antioxidants such as polymerized 2,2,4-trimethyl-1,2-dihydroquinoline; monophenolic antioxidants such as 2,6-di-t-butyl-4-methylphenol and styrenated phenol; and bis-, tris-, or polyphenolic antioxidants such as tetrakis [methylene-3-(3′,5′-di-t-butyl-4′-hydroxyphenyl) propionate]methane. Usable commercial products are available from Seiko Chemical Co., Ltd., Sumitomo Chemical Co., Ltd., Ouchi Shinko Chemical Industrial Co., Ltd., Flexsys, etc. These may be used alone or in combinations of two or more.

The amount of antioxidants per 100 parts by mass of the rubber component in the rubber composition for a tire external layer component is preferably 0.5 parts by mass or more, more preferably 0.8 parts by mass or more, still more preferably 1.0 parts by mass or more, while it is preferably 10.0 parts by mass or less, more preferably 6.0 parts by mass or less, still more preferably 4.0 parts by mass or less, further preferably 3.5 parts by mass or less. When the amount is within the range indicated above, the advantageous effect tends to be better achieved.

The rubber composition for a tire external layer component may contain a wax.

Non-limiting examples of the wax include petroleum waxes such as paraffin waxes and microcrystalline waxes; naturally-occurring waxes such as plant waxes and animal waxes; and synthetic waxes such as polymers of ethylene, propylene, or other similar monomers. Usable commercial products are available from Ouchi Shinko Chemical Industrial Co., Ltd., Nippon Seiro Co., Ltd., Seiko Chemical Co., Ltd., etc. These may be used alone or in combinations of two or more.

The amount of waxes per 100 parts by mass of the rubber component in the rubber composition for a tire external layer component is preferably 0.5 parts by mass or more, more preferably 1.0 parts by mass or more, still more preferably 1.4 parts by mass or more, while it is preferably 10 parts by mass or less, more preferably 6 parts by mass or less. When the amount is within the range indicated above, the advantageous effect tends to be better achieved.

The rubber composition for a tire external layer component may contain stearic acid.

The stearic acid may be conventional one. Usable commercial products are available from NOF Corporation, Kao Corporation, FUJIFILM Wako Pure Chemical Corporation, Chiba Fatty Acid Co., Ltd., etc. These may be used alone or in combinations of two or more.

The amount of stearic acid per 100 parts by mass of the rubber component in the rubber composition for a tire external layer component is preferably 0.5 parts by mass or more, more preferably 1.0 parts by mass or more, still more preferably 1.5 parts by mass or more, further preferably 2.4 parts by mass or more, while it is preferably 10.0 parts by mass or less, more preferably 6.0 parts by mass or less. When the amount is within the range indicated above, the advantageous effect tends to be better achieved.

The rubber composition for a tire external layer component may contain sulfur.

Examples of the sulfur include those commonly used as crosslinking agents in the rubber industry, such as powdered sulfur, precipitated sulfur, colloidal sulfur, insoluble sulfur, highly dispersible sulfur, and soluble sulfur. Usable commercial products are available from Tsurumi Chemical Industry Co., Ltd., Karuizawa sulfur Co., Ltd., Shikoku Chemicals Corporation, Flexsys, Nippon Kanryu Industry Co., Ltd., Hosoi Chemical Industry Co., Ltd., etc. These may be used alone or in combinations of two or more.

The amount of sulfur per 100 parts by mass of the rubber component in the rubber composition for a tire external layer component is preferably 0.5 parts by mass or more, more preferably 1.0 parts by mass or more, still more preferably 1.2 parts by mass or more, further preferably 1.5 parts by mass or more, particularly preferably 2.0 parts by mass or more, while it is preferably 3.5 parts by mass or less, more preferably 2.8 parts by mass or less, still more preferably 2.5 parts by mass or less, further preferably 2.4 parts by mass or less. When the amount is within the range indicated above, the advantageous effect tends to be better achieved.

The rubber composition for a tire external layer component may contain a vulcanization accelerator.

Examples of the vulcanization accelerator include thiazole vulcanization accelerators such as 2-mercaptobenzothiazole and di-2-benzothiazolyl disulfide; thiuram vulcanization accelerators such as tetramethylthiuram disulfide (TMTD) and tetrakis(2-ethylhexyl) thiuram disulfide (TOT-N); sulfenamide vulcanization accelerators such as N-cyclohexyl-2-benzothiazylsulfenamide (CBS), N-tert-butyl-2-benzothiazolylsulfenamide (TBBS), N-oxyethylene-2-benzothiazole sulfenamide, and N,N′-diisopropyl-2-benzothiazole sulfenamide; and guanidine vulcanization accelerators such as diphenylguanidine, diorthotolylguanidine, and orthotolylbiguanidine. Usable commercial products are available from Sumitomo Chemical Co., Ltd., Ouchi Shinko Chemical Industrial Co., Ltd., etc. These may be used alone or in combinations of two or more.

The amount of vulcanization accelerators per 100 parts by mass of the rubber component in the rubber composition for a tire external layer component is preferably 1.0 parts by mass or more, more preferably 1.2 parts by mass or more, still more preferably 2.0 parts by mass or more, further preferably 2.5 parts by mass or more, further preferably 2.9 parts by mass or more, while it is preferably 10 parts by mass or less, more preferably 8 parts by mass or less, still more preferably 7 parts by mass or less. When the amount is within the range indicated above, the advantageous effect tends to be better achieved.

In addition to the above-described components, the rubber composition for a tire external layer component may further contain additives commonly used in the tire industry, such as organic peroxides. The amount of each additive is preferably 0.1 to 200 parts by mass per 100 parts by mass of the rubber component.

In order to better achieve the advantageous effect, in the rubber composition for a tire external layer component, the amount P (parts by mass) of the acid-modified liquid polymer per 100 parts by mass of the rubber component and the amount F (parts by mass) of the metal filler per 100 parts by mass of the rubber component desirably satisfy the following formula:

$$0.5 \leq P / F \leq 20.0 .$$

This tire can obtain the above-described advantageous effect probably because of the following reason. Too small an amount of the metal filler results in insufficient hardness of the island phases, failing to stop cracks. On the other hand, when the amount of the metal filler reaches a certain amount or more, the effect to stop cracks will remain unchanged. Thus, the crack growth resistance is significantly increased by satisfying “0.5≤P/F≤20.0”.

The lower limit of the ratio P/F is preferably 1.0 or higher, more preferably 2.6 or higher, still more preferably 2.8 or higher. The upper limit of the ratio P/F is preferably 10.0 or lower, more preferably 5.0 or lower, still more preferably 4.9 or lower, further preferably 4.7 or lower, further preferably 4.5 or lower, further preferably 4.2 or lower, further preferably 4.1 or lower, further preferably 4.0 or less, further preferably 3.8 or lower, further preferably 3.6 or lower, further preferably 3.4 or lower, further preferably 3.3 or lower. When the ratio is within the range indicated above, the advantageous effect tends to be better achieved.

In order to better achieve the advantageous effect, in the rubber composition for treads, the amount Pt (% by mass) of the acid-modified liquid polymer per 100 parts by mass of the rubber component and the amount Ft (parts by mass) of the metal filler per 100 parts by mass of the rubber component desirably satisfy the following formula:

$$0 \text{.5} \leq Pt / Ft \leq 10. .$$

The lower limit of the ratio Pt/Ft is preferably 1.0 or higher, more preferably 2.8 or higher. The upper limit of the ratio Pt/Ft is preferably 5.0 or lower, more preferably 4.9 or lower, still more preferably 4.5 or lower, further preferably 4.2 or lower, further preferably 4.0 or less, further preferably 3.8 or lower, further preferably 3.4 or lower. When the ratio is within the range indicated above, the advantageous effect tends to be better achieved.

In order to better achieve the advantageous effect, in the rubber composition for sidewalls, the amount Ps (% by mass) of the acid-modified liquid polymer per 100 parts by mass of the rubber component and the amount Fs (parts by mass) of the metal filler per 100 parts by mass of the rubber component desirably satisfy the following formula: 0.5≤Ps/Fs≤10.0.

The lower limit of the ratio Ps/Fs is preferably 1.0 or higher, more preferably 2.6 or higher. The upper limit of the ratio Ps/Fs is preferably 5.0 or lower, more preferably 4.7 or lower, still more preferably 4.5 or lower, further preferably 4.1 or lower, further preferably 4.0 or lower, further preferably 3.6 or lower, further preferably 3.3 or lower. When the ratio is within the range indicated above, the advantageous effect tends to be better achieved.

The rubber composition may be prepared, for example, by kneading the above-described components using a rubber kneading machine such as an open roll mill or a Banbury mixer and then vulcanizing the kneaded mixture.

The kneading conditions are as follows. In a base kneading step of kneading additives other than vulcanizing agents and vulcanization accelerators, the kneading temperature is usually 100° C. to 180° C., preferably 120° C. to 170° C. In a final kneading step of kneading vulcanizing agents and vulcanization accelerators, the kneading temperature is usually 120° C. or lower, preferably 80° C. to 115° C., more preferably 85° C. to 110° C. Then, the composition obtained after kneading vulcanizing agents and vulcanization accelerators is usually vulcanized by, for example, press vulcanization. The vulcanization temperature is usually 140° C. to 190° C., preferably 150° C. to 185° C. The vulcanization time is usually 3 to 20 minutes, preferably 5 to 15 minutes.

### (Tire)

The tire of the present disclosure includes a tire external layer component that includes the rubber composition for a tire external layer component. The amount F (parts by mass) of the metal filler per 100 parts by mass of the rubber component in the rubber composition for a tire external layer component and the largest thickness T (mm) of the tire external layer component satisfy the following formula (1):

$$0.4 \leq F / T \leq 10.0 . \qquad ( 1 )$$

The lower limit of the ratio F/T is preferably 0.6 or higher, more preferably 0.7 or higher, still more preferably 0.8 or higher, further preferably 0.9 or higher, further preferably 1.0 or higher, further preferably 1.4 or higher, further preferably 1.5 or higher, further preferably 1.6 or higher, further preferably 1.8 or higher, further preferably 2.0 or higher. The upper limit of the ratio F/T is preferably 5.0 or lower, more preferably 4.5 or lower. When the ratio is within the range indicated above, the advantageous effect tends to be better achieved.

The largest thickness T of the tire external layer component is preferably 2.0 mm or more, more preferably 2.5 mm or more, still more preferably 2.8 mm or more, particularly preferably 3.0 mm or more. The upper limit is preferably 8.0 mm or less, more preferably 7.0 mm or less, still more preferably 6.0 mm or less, particularly preferably 5.0 mm or less. When the largest thickness is within the range indicated above, the advantageous effect tends to be better achieved.

The largest thickness T of the tire external layer component refers to the largest value of the thickness of each tire external layer component (sidewall, tread, or the like) constituting each rubber layer. The thickness at a point on the surface of each tire external layer component is measured at the point along the normal of the surface of the tire external layer component. The largest thickness T of the tire external layer component is the maximum value of the thickness at the point.

Herein, the dimensions (dimensions including the largest thicknesses of tire external layer components such as the largest thickness of a tread and the largest thickness of a sidewall) and angles of the tire components are measured while the tire is mounted on a normal rim and filled with air to a normal internal pressure (also referred to as “in a normal state”), unless otherwise stated. No load is applied to the tire during the measurement. In the case of a passenger car tire, the dimensions and angles are measured at an internal pressure of 180 kPa.

The term “normal rim” refers to a rim specified by a standard according to which tires are provided, and may be “standard rim” in the JATMA standard, “design rim” in the TRA standard, or “measuring rim” in the ETRTO standard. The term “normal internal pressure” refers to an internal pressure specified by a standard according to which the tire 1 is provided. The “maximum air pressure” in the JATMA standard, the “maximum value” shown in “TIRE LOAD LIMITS AT VARIOUS COLD INFLATION PRESSURES” in the TRA standard, and “inflation pressure” in the ETRTO standard are each a normal internal pressure.

The tire of the present disclosure is described in detail below based on, but not limited to, an exemplary preferred embodiment with appropriate reference to the drawings.

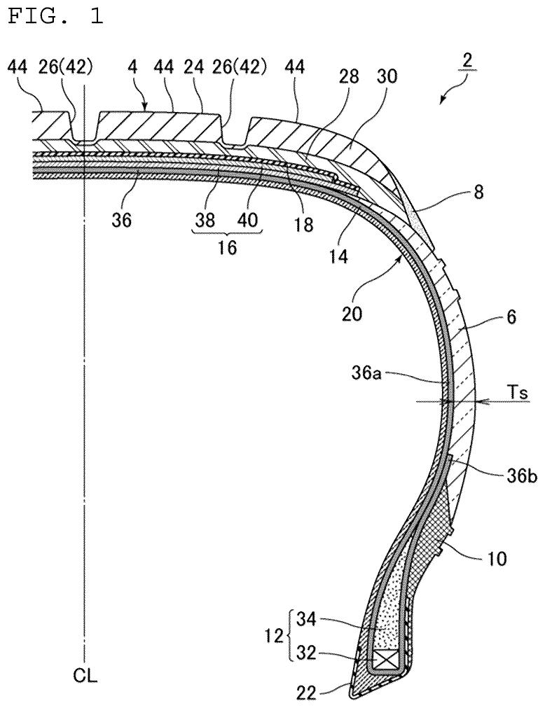

FIG. 1 shows a pneumatic tire 2. In FIG. 1, the vertical direction corresponds to the radial direction of the tire 2, the horizontal direction corresponds to the axial direction of the tire 2, and the direction perpendicular to the paper corresponds to the circumferential direction of the tire 2. In FIG. 1, the dash-dot-dash line CL represents the equator of the tire 2. The shape of the tire 2 is symmetrical to the equator, except for the tread pattern.

The tire 2 includes a tread 4, a pair of sidewalls 6, a pair of wings 8, a pair of clinches 10, a pair of beads 12, a carcass 14, a belt 16, a band 18, an innerliner 20, and a pair of chafers 22. The tire 2 is a tubeless tire. The tire 2 will be mounted on a passenger vehicle.

The tread 4 has a radially outwardly convex shape. The tread 4 forms a tread face 24 that will contact the road surface. The tread 4 has grooves 26 engraved thereon. The grooves 26 define a tread pattern. The tread 4 has a base layer 28 and a cap layer 30. The cap layer 30 is located radially outward of the base layer 28. The cap layer 30 is stacked on the base layer 28.

Although FIG. 1 shows an example of the two-layer tread 4 including the cap layer 30 and the base layer 28, the tread 4 may be a monolayer tread or a three or more-layer tread.

In an exemplary embodiment of the tire 2 in FIG. 1, the amount Ft (parts by mass) of the metal filler per 100 parts by mass of the rubber component in the tread 4 and the largest thickness Tt (mm) of the tread 4 satisfy the following formula:

$$0.4 \leq F t / Tt \leq 10. .$$

The lower limit of the ratio Ft/Tt is preferably 0.6 or higher, more preferably 0.7 or higher, still more preferably 0.8 or higher, further preferably 0.9 or higher, further preferably 1.0 or higher. The upper limit of the ratio Ft/Tt is preferably 5.0 or lower, more preferably 4.5 or lower. When the ratio is within the range indicated above, the advantageous effect tends to be better achieved.

The largest thickness Tt of the tread 4 is preferably 3.0 mm or more, more preferably 4.0 mm or more, still more preferably 4.5 mm or more, particularly preferably 5.0 mm or more. The upper limit is preferably 8.0 mm or less, more preferably 7.0 mm or less, still more preferably 6.0 mm or less, further preferably 5.5 mm or less. When the thickness is within the range indicated above, the advantageous effect tends to be better achieved.

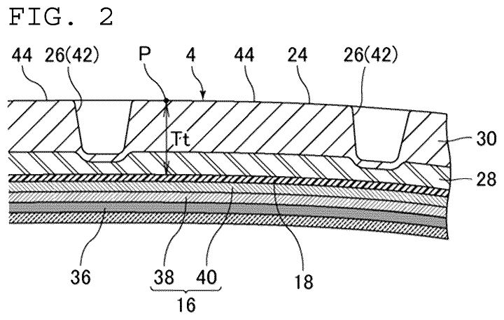

FIG. 2 shows an enlarged cross-sectional view of the tread 4 and its vicinity of the tire 2 in FIG. 1. In FIG. 2, the vertical direction corresponds to the radial direction of the tire 2, the horizontal direction corresponds to the axial direction of the tire 2, and the direction perpendicular to the paper corresponds to the circumferential direction of the tire 2.

In FIG. 2, the symbol P denotes a point on the tread face 24. The point P is located outwardly of the axially innermost groove 26. The double-headed arrow Tt denotes the thickness of the tread 4 at the point P. The thickness T is a total thickness of the cap layer 30 and the base layer 28 at the point P. The thickness T is measured along the normal of the tread face 24 at the point P. FIGS. 1 and 2 show an example of a two-layer tread 4 including the cap layer 30 and the base layer 28. In the case of a monolayer tread 4, the thickness T of the tread refers to the thickness of the monolayer tread at the point P. In the case of a three or more-layer tread, the thickness T of the tread refers to a total thickness of the three or more layers at the point P, and the thickness T at the point P is measured along the normal of the tread face 24 at the point P.

In FIG. 1, the largest thickness Tt of the tread 4 is the largest one (the total thickness of the cap layer 30 and the base layer 28 in FIG. 1) of the thicknesses of the tread at points on the tread face 24.

In the tire 2 in FIG. 1, each sidewall 6 extends substantially inwardly in the radial direction from an end of the tread 4. The radially outer portion of the sidewall 6 is bonded to the tread 4. The radially inner portion of the sidewall 6 is bonded to a clinch 10.

In an exemplary embodiment of the tire 2 in FIG. 1, the amount Fs (parts by mass) of the metal filler per 100 parts by mass of the rubber component in the sidewall 6 and the largest thickness Ts (mm) of the sidewall 6 satisfy the following formula:

$$0 \text{.4} \leq Fs / Ts \leq 10. .$$

The lower limit of the ratio Fs/Ts is preferably 0.6 or higher, more preferably 0.7 or higher, still more preferably 1.4 or higher, further preferably 1.5 or higher, further preferably 1.6 or higher, further preferably 1.8 or higher, further preferably 2.0 or higher. The upper limit of the ratio Fs/Ts is preferably 6.0 or lower, more preferably 5.0 or lower, still more preferably 4.5 or lower. When the ratio is within the range indicated above, the advantageous effect tends to be better achieved.

The largest thickness Ts of the sidewall 6 is preferably 2.0 mm or more, more preferably 2.5 mm or more, still more preferably 2.8 mm or more, particularly preferably 3.0 mm or more. The upper limit is preferably 6.0 mm or less, more preferably 5.0 mm or less, still more preferably 4.0 mm or less, further preferably 3.5 mm or less. When the thickness is within the range indicated above, the advantageous effect tends to be better achieved.

In the tire 2 in FIG. 1, the largest thickness Ts of the sidewall 6 is the largest one of the thicknesses of the sidewall at points on the surface of the sidewall 6. The largest thickness is denoted by Ts in the example in FIG. 1.

In the tire 2 in FIG. 1, each wing 8 is located between the tread 4 and the sidewall 6. The wing 8 is bonded to both the tread 4 and the sidewall 6.

Each clinch 10 is located substantially radially inward of the sidewall 6. The clinch 10 is located axially outwardly from a bead 12 and the carcass 14.

Each bead 12 is located axially inward of the clinch 10. Each bead 12 includes a core 32 and an apex 34 that radially outwardly extends from the core 32. The core 32 has a ring shape and contains a wound non-stretchable wire, etc. The apex 34 is radially outwardly tapered.

The carcass 14 includes a carcass ply 36. Although the carcass 14 in the tire 2 includes one carcass ply 36, the carcass 14 may include two or more carcass plies.

In the tire 2, the carcass ply 36 extends between the beads 12 on opposite sides along the tread 4 and the sidewalls 6. The carcass ply 36 is folded around each core 32 from the inside to the outside in the axial direction. Due to this folding, the carcass ply 36 is provided with a main portion 36a and a pair of folded portions 36b. Namely, the carcass ply 36 includes the main portion 36a and the pair of folded portions 36b.

Though not shown, examples of the carcass ply 36 include carcass plies which include a large number of parallel cords and a topping rubber. The carcass 14 preferably has a radial structure.

A belt 16 is located radially inward of the tread 4. The belt 16 is stacked on the carcass 14. The belt 16 includes an interior layer 38 and an exterior layer 40.

Though not shown, examples of the interior layer 38 and the exterior layer 40 each include layers which include a large number of parallel cords and a topping rubber. Each cord is tilted relative to the equator, for example. The tilt direction of the cords in the interior layer 38 relative to the equator is opposite to the tilt direction of the cords in the exterior layer 40 relative to the equator.

A band 18 is located radially outward of the belt 16. The band 18 has a width that is equal to or nearly equal to the width of the belt 16 in the axial direction. The band 18 may be wider than the belt 16.

Though not shown, examples of the band 18 include bands which include cords and a topping rubber. The cords are spirally wound, for example.

The belt 16 and the band 18 form a reinforcement layer. The reinforcement layer may be formed only of the belt 16.

An innerliner 20 is located inward of the carcass 14. The innerliner 20 is bonded to the inner surface of the carcass 14.

Each chafer 22 is located near the bead 12. In this embodiment, examples of the chafer 22 include chafers which include a rubber and a fabric impregnated with the rubber. The chafer 22 may be integrated with the clinch 10.

In the tire 2, the tread 4 has the grooves 26 including main grooves 42. As shown in FIG. 1, the tread 4 has a plurality of, specifically three, main grooves 42 engraved thereon. The main grooves 42 are positioned at intervals in the axial direction. As the three main grooves 42 are engraved on the tread 4, the tread 4 is provided with four ribs 44 extending in the circumferential direction. In other words, each main groove 42 is between one rib 44 and another rib 44.

The main grooves 42 extend in the circumferential direction. The main grooves 42 are continuous in the circumferential direction without interruption.

In the production of the tire 2, a plurality of rubber-based tire components are assembled with one another into a raw cover (unvulcanized tire 2). The raw cover is introduced into a mold. The outer surface of the raw cover contacts a cavity surface of the mold. The inner surface of the raw cover contacts a bladder or a core. The raw cover is pressurized and heated in the mold, so that the rubber composition in the raw cover flows. The heating causes a rubber crosslinking reaction to give the tire 2. The tire 2 is provided with a projection and recess pattern by using a mold having the projection and recess pattern on the cavity surface.

Examples of the tire 2 include pneumatic tires and non-pneumatic tires. Of these, the tire is preferably a pneumatic tire. In particular, the tire can be suitably used as a summer tire or a winter tire (studless tire, snow tire, studded tire, etc.), for example. The tire can be used for passenger cars, large passenger cars, large SUVs, heavy-duty vehicles such as trucks and buses, light trucks, or motorcycles, or as a racing tire (high performance tire), etc.

### EXAMPLES

Examples (working examples) which are considered preferable to implement the present disclosure are described below. Yet, the scope of the disclosure is not limited to the examples.

Compositions produced using the chemicals listed below according to the formulation varied as shown in Table 1 and tire specifications shown in Table 1 are examined. The results calculated according to the below-described evaluations are shown in the tables.
SBR: HPR355 (modified with 3-aminopropyltrimethoxisilane, styrene content: 27% by mass) available from JSR Corporation
NR: TSR20
BR: BR150B (cis content: 97% by mass) available from UBE Corporation
Maleic acid-modified liquid polyisoprene: LIR-410 (Mw: 30000) available from Kuraray
Maleic anhydride-modified liquid polyisoprene: LIR-403 (Mw: 34000) available from Kuraray
Unmodified liquid polyisoprene: LIR-50 (Mw: 54000) available from Kuraray
Maleic acid-modified liquid polybutadiene: Ricon 130MA8 (Mw: 2700) available from Clay Valley
Carbon black 1: SEAST 9H (N₂SA: 110 m²/g) available from Tokai Carbon Co., Ltd.
Carbon black 2: SHOBLACK N550 (N₂SA: 42 m²/g) available from Cabot Japan K. K.
Silica: ZEOSIL 1165MP (N₂SA: 160 m²/g) available from Rhodia
Silane coupling agent: Si75 (bis(3-triethoxysilylpropyl) disulfide) available from Degussa
Oil: Process X-140 available from ENEOS Corporation
Wax: SUNNOC wax available from Ouchi Shinko Chemical Industrial Co., Ltd.
Antioxidant: NOCRAC 6C (N-phenyl-N′-1,3-dimethylbutyl-p-phenylenediamine) available from Ouchi Shinko Chemical Industrial Co., Ltd.
Stearic acid: stearic acid “TSUBAKI” available from NOF Corporation Zinc oxide: zinc oxide #2 available from Mitsui Mining & Smelting Co., Ltd.
Sulfur: powdered sulfur available from Tsurumi Chemical Industry Co., Ltd.
Vulcanization accelerator: NOCCELER NS (N-tert-butyl-2-benzothiazolylsulfenamide) available from Ouchi Shinko Chemical Industrial Co., Ltd.

### <Production of Test Tire (Tread)>

According to the formulation and specification in Table 1, the chemicals other than the sulfur and the vulcanization accelerator are kneaded in a 1.7-L Banbury mixer (Kobe Steel, Ltd.) at 150° C. for four minutes. Next, the kneaded mixture is kneaded with the sulfur and the vulcanization accelerator using an open roll mill at 80° C. for five minutes to produce an unvulcanized rubber composition.

The unvulcanized rubber composition is formed into the shape of a tread and then assembled with other tire components on a tire building machine. The resulting unvulcanized tire is press-vulcanized at 170° C. for 20 minutes, whereby a test tire (size: 195/65R15) is produced.

### <Production of Test Tire (Sidewall)>

According to the formulation and specification in Table 1, the chemicals other than the sulfur and the vulcanization accelerator are kneaded in a 1.7-L Banbury mixer (Kobe Steel, Ltd.) at 150° C. for four minutes. Next, the kneaded mixture is kneaded with the sulfur and the vulcanization accelerator using an open roll mill at 80° C. for five minutes to produce an unvulcanized rubber composition.

The unvulcanized rubber composition is formed into the shape of a sidewall and then assembled with other tire components on a tire building machine. The resulting unvulcanized tire is press-vulcanized at 170° C. for 20 minutes, whereby a test tire (size: 195/65R15) is produced.

The produced test tires are subjected to measurement of physical properties and evaluations as described below. The reference comparative examples in the tables are as follows.
Table 1: Comparative Example 1-1
Table 2: Comparative Example 2-1
   <Crack Growth Resistance after Aging>

The state of the test tires after degradation over time is simulated by mounting the test tires on rims, thermally degrading the test tires filled with air at 80° C. for three weeks, mounting the test tires on a vehicle, and driving the vehicle for 40000 km. After the driving, the cracking state (depth, number, length) of a cap tread portion in each test tire (tread) and that of a sidewall portion in each test tire (sidewall) are evaluated. The evaluation results are expressed as indices relative to the result in the reference comparative example taken as 100. A higher index indicates better crack growth resistance.

TABLE 1

| | | Comparative Example | | | Example | | | | | | | | |
|---|---|---|---|---|---|---|---|---|---|---|---|---|---|
| | | 1-1 | 1-2 | 1-3 | 1-1 | 1-2 | 1-3 | 1-4 | 1-5 | 1-6 | 1-7 | 1-8 | 1-9 |
| Formulation | SBR | 85 | 85 | 82 | 82 | 82 | 82 | 82 | 82 | 82 | 82 | 82 | 82 |
| (parts | BR | 15 | 15 | 18 | 18 | 18 | 18 | 18 | 18 | 18 | 18 | 18 | 18 |
| by | Maleic acid-modified liquid polyisoprene | | | | 18 | | 18 | 18 | 18 | 18 | 13 | 23 | |
| mass) | Maleic anhydride-modified liquid | | | | | 18 | | | | | | | |
| | polyisoprene | | | | | | | | | | | | |
| | Unmodified liquid polyisoprene | | | 18 | | | | | | | | | |
| | Maleic acid-modified liquid polybutadiene | | | | | | | | | | | | 18 |
| | Carbon black 1 | 6 | 6 | 6 | 6 | 6 | 6 | 6 | 6 | 6 | 6 | 6 | 6 |
| | Silica | 71 | 71 | 71 | 71 | 71 | 71 | 71 | 71 | 71 | 71 | 71 | 71 |
| | Silane coupling agent | 5.6 | 5.6 | 5.6 | 5.6 | 5.6 | 5.6 | 5.6 | 5.6 | 5.6 | 5.6 | 5.6 | 5.6 |
| | Zinc oxide | 1.8 | 4.7 | 4.7 | 4.7 | 4.7 | 4.2 | 5.2 | 4.7 | 4.7 | 4.7 | 4.7 | 4.7 |
| | Stearic acid | 2.4 | 2.4 | 2.4 | 2.4 | 2.4 | 2.4 | 2.4 | 2.4 | 2.4 | 2.4 | 2.4 | 2.4 |
| | Sulfur | 1.2 | 1.2 | 1.2 | 1.2 | 1.2 | 1.2 | 1.2 | 1.2 | 1.2 | 1.2 | 1.2 | 1.2 |
| | Vulcanization accelerator | 2.9 | 2.9 | 2.9 | 2.9 | 2.9 | 2.9 | 2.9 | 2.9 | 2.9 | 2.9 | 2.9 | 2.9 |
| Specification | Largest thickness Tt (mm) of tread | 5.0 | 5.0 | 5.0 | 5.0 | 5.0 | 5.0 | 5.0 | 4.5 | 5.5 | 5.0 | 5.0 | 5.0 |
| | Ft/Tt | 0.4 | 0.9 | 0.9 | 0.9 | 0.9 | 0.8 | 1.0 | 1.0 | 0.9 | 0.9 | 0.9 | 0.9 |
| | Pt/Ft | 0.0 | 0.0 | 0.0 | 3.8 | 3.8 | 4.2 | 3.4 | 3.8 | 3.8 | 2.8 | 4.9 | 3.8 |
| Evaluation | Crack growth resistance index | 100 | 99 | 33 | 400 | 200 | 378 | 418 | 425 | 380 | 226 | 950 | 180 |

| | | Comparative Example | | | Example | | | | | | | | |
|---|---|---|---|---|---|---|---|---|---|---|---|---|---|
| | | 2-1 | 2-2 | 2-3 | 2-1 | 2-2 | 2-3 | 2-4 | 2-5 | 2-6 | 2-7 | 2-8 | 2-9 |
| Formulation | NR | 50 | 50 | 41 | 41 | 41 | 41 | 41 | 41 | 41 | 41 | 41 | 41 |
| (parts | BR | 50 | 50 | 59 | 59 | 59 | 59 | 59 | 59 | 59 | 59 | 59 | 59 |
| by | Maleic acid-modified liquid polyisoprene | | | | 18 | | 18 | 18 | 18 | 18 | 13 | 23 | |
| mass) | Maleic anhydride-modified liquid | | | | | 18 | | | | | | | |
| | polyisoprene | | | | | | | | | | | | |
| | Unmodified liquid polyisoprene | | | 18 | | | | | | | | | |
| | Maleic acid-modified liquid polybutadiene | | | | | | | | | | | | 18 |
| | Carbon black 2 | 47 | 47 | 47 | 47 | 47 | 47 | 47 | 47 | 47 | 47 | 47 | 47 |
| | Oil | 12 | 12 | 12 | 12 | 12 | 12 | 12 | 12 | 12 | 12 | 12 | 12 |
| | Wax | 1.4 | 1.4 | 1.4 | 1.4 | 1.4 | 1.4 | 1.4 | 1.4 | 1.4 | 1.4 | 1.4 | 1.4 |
| | Antioxidant | 3.5 | 3.5 | 3.5 | 3.5 | 3.5 | 3.5 | 3.5 | 3.5 | 3.5 | 3.5 | 3.5 | 3.5 |
| | Zinc oxide | 1.1 | 4.9 | 4.9 | 4.9 | 4.9 | 4.4 | 5.4 | 4.9 | 4.9 | 4.9 | 4.9 | 4.9 |
| | Stearic acid | 2.4 | 2.4 | 2.4 | 2.4 | 2.4 | 2.4 | 2.4 | 2.4 | 2.4 | 2.4 | 2.4 | 2.4 |
| | Sulfur | 2.4 | 2.4 | 2.4 | 2.4 | 2.4 | 2.4 | 2.4 | 2.4 | 2.4 | 2.4 | 2.4 | 2.4 |
| | Vulcanization accelerator | 1.2 | 1.2 | 1.2 | 1.2 | 1.2 | 1.2 | 1.2 | 1.2 | 1.2 | 1.2 | 1.2 | 1.2 |
| Specification | Largest thickness Ts (mm) of sidewall | 3.0 | 3.0 | 3.0 | 3.0 | 3.0 | 3.0 | 3.0 | 2.5 | 3.5 | 3.0 | 3.0 | 3.0 |
| | Fs/Ts | 0.4 | 1.6 | 1.6 | 1.6 | 1.6 | 1.5 | 1.8 | 2.0 | 1.4 | 1.6 | 1.6 | 1.6 |
| | Ps/Fs | 0.0 | 0.0 | 0.0 | 3.6 | 3.6 | 4.1 | 3.3 | 3.6 | 3.6 | 2.6 | 4.7 | 3.6 |
| Evaluation | Crack growth resistance index | 100 | 100 | 31 | 374 | 177 | 350 | 388 | 390 | 356 | 190 | 730 | 160 |

The tires in the examples that include a tire external layer component including a rubber composition containing a rubber component, an acid-modified liquid polymer, and a metal filler and also satisfy the formula (1) are excellent in crack growth resistance, especially excellent in crack growth resistance after aging.

The present disclosure (1) relates to a tire, including a tire external layer component including a rubber composition that contains a rubber component, an acid-modified liquid polymer, and a metal filler,
the tire satisfying the following formula (1):

$$0.4 \leq F / T \leq 10.0 \qquad ( 1 )$$

where F denotes an amount (parts by mass) of the metal filler per 100 parts by mass of the rubber component, and T denotes a largest thickness (mm) of the tire external layer component.

The present disclosure (2) is the tire according to the present disclosure (1),
wherein the tire satisfies the following formula:

$$0.5 \leq P / F \leq 20.0$$

where P denotes an amount (parts by mass) of the acid-modified liquid polymer per 100 parts by mass of the rubber component, and F denotes an amount (parts by mass) of the metal filler.

The present disclosure (3) is the tire according to the present disclosure (1) or (2),
wherein the acid-modified liquid polymer includes at least one selected from the group consisting of maleic acid-modified liquid diene-based polymers and maleic anhydride-modified liquid diene-based polymers.

The present disclosure (4) is the tire according to any one of the present disclosures (1) to (3),
wherein the metal filler is zinc oxide.

The present disclosure (5) is the tire according to any one of the present disclosures (1) to (4),
wherein the rubber composition contains, per 100 parts by mass of the rubber component, 5 to 35 parts by mass of the acid-modified liquid polymer and 0.5 to 50.0 parts by mass of the metal filler.

The present disclosure (6) is the tire according to any one of the present disclosures (1) to (5),
wherein the rubber composition contains at least one of carbon black or silica.

The present disclosure (7) is the tire according to any one of the present disclosures (1) to (6),
wherein the rubber component includes polybutadiene rubber and at least one of an isoprene-based rubber or styrene-butadiene rubber.

The present disclosure (8) is the tire according to any one of the present disclosures (1) to (7),
wherein the largest thickness T (mm) of the tire external layer component satisfies the following formula:

$$2. mm \leq T \leq 6.0 mm .$$

The present disclosure (9) is the tire according to any one of the present disclosures (1) to (8),
wherein the tire external layer component is at least one selected from the group consisting of a tread and a sidewall.

The present disclosure (10) is the tire according to any one of the present disclosures (1) to (9),
wherein the tire external layer component is a tread, and
the tire satisfies the following formula:

$$0.6 \leq Ft / Tt \leq 5.$$

where Ft denotes an amount (parts by mass) of the metal filler per 100 parts by mass of the rubber component, and Tt denotes a largest thickness (mm) of the tread.

The present disclosure (11) is the tire according to any one of the present disclosures (1) to (10),
wherein the tire external layer component is a tread, and
the tire satisfies the following formula:

$$1 \text{.0} \leq Pt / Ft \leq 10.$$

where Pt denotes an amount (parts by mass) of the acid-modified liquid polymer per 100 parts by mass of the rubber component, and Ft denotes an amount (parts by mass) of the metal filler.

The present disclosure (12) is the tire according to any one of the present disclosures (1) to (11),
wherein the tire external layer component is a tread, and
the largest thickness Tt (mm) of the tread satisfies the following formula:

$$3. mm \leq Tt \leq 6. mm .$$

The present disclosure (13) is the tire according to any one of the present disclosures (1) to (9),
wherein the tire external layer component is a sidewall, and
the tire satisfies the following formula:

$$0 \text{.6} \leq Fs / Ts \leq 5.0$$

where Fs denotes an amount (parts by mass) of the metal filler per 100 parts by mass of the rubber component, and Ts denotes a largest thickness (mm) of the sidewall.

The present disclosure (14) is the tire according to any one of the present disclosures (1) to (9) and (13),
wherein the tire external layer component is a sidewall, and
the tire satisfies the following formula:

$$1 \text{.0} \leq Ps / Fs \leq 10.0$$

where Ps denotes an amount (parts by mass) of the acid-modified liquid polymer per 100 parts by mass of the rubber component, and Fs denotes an amount (parts by mass) of the metal filler.

The present disclosure (15) is the tire according to any one of the present disclosures (1) to (9), (13), and (14),
wherein the tire external layer component is a sidewall, and
the largest thickness Ts (mm) of the sidewall satisfies the following formula:

$$2. mm \leq Ts \leq 5. mm .$$

### REFERENCE SIGNS LIST

2 pneumatic tire
4 tread
6 sidewall
8 wing
10 clinch
12 bead
14 carcass
16 belt
18 band
20 innerliner
22 chafer
24 tread face
26 groove
28 base layer
30 cap layer
32 core
34 apex
36 carcass ply
36a main portion
36b folded portion
38 interior layer
40 exterior layer
42 main groove
44 rib
CL equator of tire 2
P point on tread face 24
Tt largest thickness of tread 4
Ts largest thickness of sidewall 6

1. A tire, comprising a tire external layer component comprising a rubber composition that comprises a rubber component, an acid-modified liquid polymer, and a metal filler,
the tire satisfying the following formula (1):
$$0. 4 \leq F / T \leq 10.0 \qquad ( 1 )$$
where F denotes an amount (parts by mass) of the metal filler per 100 parts by mass of the rubber component, and T denotes a largest thickness (mm) of the tire external layer component.

2. The tire according to claim 1,
wherein the tire satisfies the following formula:
$$0.5 \leq P / F \leq 20.0$$
where P denotes an amount (parts by mass) of the acid-modified liquid polymer per 100 parts by mass of the rubber component, and F denotes an amount (parts by mass) of the metal filler.

3. The tire according to claim 1,
wherein the acid-modified liquid polymer comprises at least one selected from the group consisting of maleic acid-modified liquid diene-based polymers and maleic anhydride-modified liquid diene-based polymers.

4. The tire according to claim 1,
wherein the metal filler is zinc oxide.

5. The tire according to claim 1,
wherein the rubber composition comprises, per 100 parts by mass of the rubber component, 5 to 35 parts by mass of the acid-modified liquid polymer and 0.5 to 50.0 parts by mass of the metal filler.

6. The tire according to claim 1,
wherein the rubber composition comprises at least one of carbon black or silica.

7. The tire according to claim 1,
wherein the rubber component comprises polybutadiene rubber and at least one of an isoprene-based rubber or styrene-butadiene rubber.

8. The tire according to claim 1,
wherein the largest thickness T (mm) of the tire external layer component satisfies the following formula:
$$2. mm \leq T \leq 6.0 mm .$$

9. The tire according to claim 1,
wherein the tire external layer component is at least one selected from the group consisting of a tread and a sidewall.

10. The tire according to claim 1,
wherein the tire external layer component is a tread, and
the tire satisfies the following formula:
$$0.6 \leq Ft / Tt \leq 5.$$
where Ft denotes an amount (parts by mass) of the metal filler per 100 parts by mass of the rubber component, and Tt denotes a largest thickness (mm) of the tread.

11. The tire according to claim 1,
wherein the tire external layer component is a tread, and
the tire satisfies the following formula:
$$1. \leq Pt / Ft \leq 10.0$$
where Pt denotes an amount (parts by mass) of the acid-modified liquid polymer per 100 parts by mass of the rubber component, and Ft denotes an amount (parts by mass) of the metal filler.

12. The tire according to claim 1,
wherein the tire external layer component is a tread, and
the largest thickness Tt (mm) of the tread satisfies the following formula:
$$3. mm \leq Tt \leq 6. mm .$$

13. The tire according to claim 1,
wherein the tire external layer component is a sidewall, and
the tire satisfies the following formula:
$$0.6 \leq Fs / Ts \leq 5.$$
where Fs denotes an amount (parts by mass) of the metal filler per 100 parts by mass of the rubber component, and Ts denotes a largest thickness (mm) of the sidewall.

14. The tire according to claim 1,
wherein the tire external layer component is a sidewall, and
the tire satisfies the following formula:
$$1. \leq Ps / Fs \leq 10.0$$
where Ps denotes an amount (parts by mass) of the acid-modified liquid polymer per 100 parts by mass of the rubber component, and Fs denotes an amount (parts by mass) of the metal filler.

15. The tire according to claim 1,
wherein the tire external layer component is a sidewall, and
the largest thickness Ts (mm) of the sidewall satisfies the following formula:
$$2. mm \leq Ts \leq 5. mm .$$
